(19) United States
(12) Patent Application Publication
(10) Pub. No.: US 2024/0322291 A1
(43) Pub. Date: Sep. 26, 2024

(54) BATTERY PACK

(71) Applicant: HONDA MOTOR CO., LTD., Tokyo (JP)

(72) Inventor: Yasushi OGIHARA, Saitama (JP)

(73) Assignee: HONDA MOTOR CO., LTD., Tokyo (JP)

(21) Appl. No.: 18/588,029

(22) Filed: Feb. 27, 2024

(30) Foreign Application Priority Data
Mar. 22, 2023 (JP) 2023-045862

(51) Int. Cl. H01M 10/6553; H01M 10/613; H01M 10/63; H01M 10/6551; H01M 10/6563; H01M 10/6568; H01M 50/211

(52) U.S. Cl. CPC H01M 10/6553; H01M 10/613; H01M 10/63; H01M 10/6551; H01M 10/6563; H01M 10/6568; H01M 50/211

(57) ABSTRACT

A battery pack includes cells having a positive terminal and a negative terminal, battery modules in which the cells are laminated, a battery case accommodating the battery modules, and a water jacket connected to a heat exchange system and configured to cool the battery modules from below. The battery case includes a first section in which the battery modules are arranged, and heat exchange between the battery modules and the water jacket is performed, a second section provided above the water jacket, and in which no battery module is disposed, a gap provided between the cells and an inner wall of the battery case, and through which air is capable of passing, a fin provided in the second section, and formed to protrude from a side of the water jacket, and a fan circulating air across the first section and the second section.

### CROSS-REFERENCE TO RELATED APPLICATIONS

This application is based on and claims priority under 35 USC 119 from Japanese Patent Application No. 2023-045862 filed on Mar. 22, 2023, the entire content of which is incorporated herein by reference.

### TECHNICAL FIELD

The present disclosure relates to a battery pack capable of being mounted on a moving body such as a vehicle.

### BACKGROUND ART

In recent years, efforts to implement a low-carbon society or a decarbonized society become active, and research and development of electrification technique are conducted to reduce CO2 emission and improve energy efficiency in vehicles.

Batteries play an important role in the electrification technique. Since the battery is a heat-generating component, from the viewpoint of safety and prevention of battery deterioration, current is limited when the battery reaches a predetermined temperature or higher. Therefore, for example, a water jacket is provided in a battery pack, and cooling control of the battery is performed so that the temperature of the battery is maintained within a desired temperature range.

JP2003-297439A describes that a water jacket is provided between batteries arranged in a plurality of rows, and a cooling fan is provided to supply air from a rear side to a front side of a battery case.

However, with recent battery development, a heat resistant temperature of cells that constitute a battery module becomes higher. Therefore, in the related art, it was sufficient to cool the cells that constitute the battery module, but in recent years, although temperatures of the cells do not reach a critical temperature for limiting the current, there is a risk that terminal temperatures of the cells will reach the critical temperature for limiting the current.

The battery cooling method described in JP2003-297439A can cool a surface of the battery module on an outer side in a vehicle width direction by the air supplied by the cooling fan, but does not mention cooling for cell terminals.

### SUMMARY OF INVENTION

The present disclosure provides a battery pack capable of cooling a body of a cell in a battery module and of appropriately cooling a cell terminal.

An aspect of the present disclosure relates to a battery pack, having:
a plurality of cells having a positive terminal and a negative terminal;
a plurality of battery modules in which the plurality of cells are laminated;
a battery case accommodating the plurality of battery modules; and
a water jacket connected to a heat exchange system outside the battery case with a pipe and provided inside or outside the battery case to cool the plurality of battery modules from below,
in which the battery case includes:
   a first section in which the plurality of battery modules are arranged, and heat exchange between the plurality of battery modules and the water jacket is performed;
   a second section provided above the water jacket, and in which no battery module is disposed;
   a gap provided between the plurality of cells and an inner wall of the battery case, and through which air is capable of passing;
   a fin provided in the second section, and formed to protrude from a side of the water jacket; and
   a fan circulating air across the first section and the second section.

According to the present disclosure, a body of the cell in the battery module can be cooled, and further, the cell terminal can also be appropriately cooled.

### BRIEF DESCRIPTION OF DRAWINGS

Exemplary embodiment(s) of the present invention will be described in detail based on the following figures, wherein:

FIG. 1 is an exploded perspective view of a battery pack 1 according to a first embodiment;

FIG. 2 is an exploded perspective view of a battery module 10;

FIG. 3 is a perspective view of a laminated cell 21;

FIG. 4 is a perspective view showing a bus bar 22 connecting electrode tabs 212 of each laminated cell 21;

FIG. 5 is a plan view showing an internal structure of the battery pack 1;

FIG. 6 is a cross-sectional view taken along a line A-A in FIG. 5;

FIG. 7 is a cross-sectional view taken along a line B-B in FIG. 5;

FIG. 8 is a cross-sectional view taken along a line C-C in FIG. 5;

FIG. 9 is a cross-sectional view taken along a line D-D in FIG. 5;

FIG. 10 is a plan view showing the internal structure of the battery pack 1, which schematically shows a flow of air caused by a fan 13;

FIG. 11 is a diagram showing a battery cooling circuit;

FIG. 12 is a graph illustrating battery cooling control;

FIG. 13 is a plan view showing an internal structure of a battery pack 1A of a second embodiment, and also schematically showing the flow of air caused by the fan 13; and

FIG. 14 is a cross-sectional view taken along a line E-E in FIG. 13.

### DESCRIPTION OF EMBODIMENTS

Hereinafter, a battery pack of each embodiment of the present disclosure is described based on the accompanying drawings.

### First Embodiment

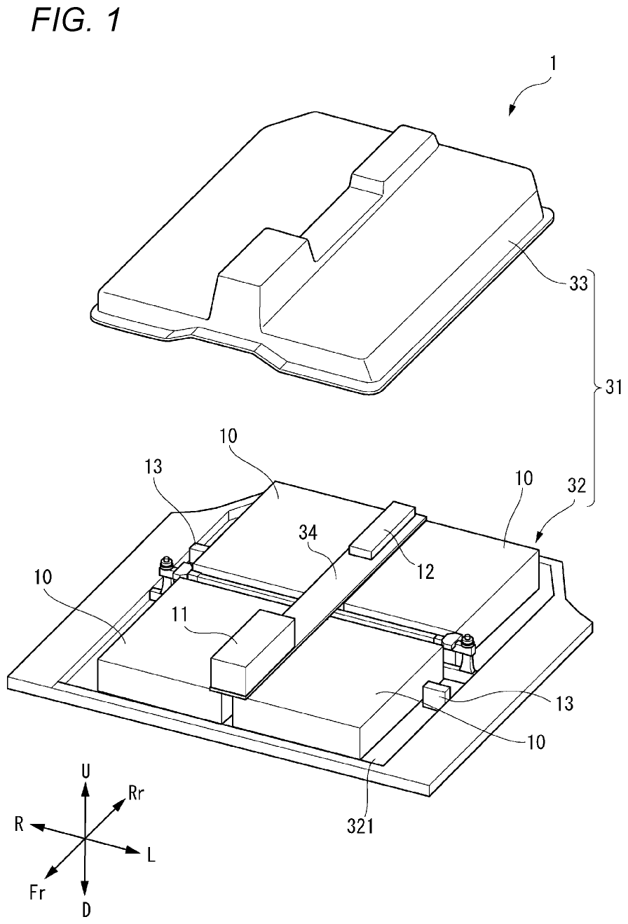

A battery pack 1 according to a first embodiment of the present disclosure is configured to be able to be mounted on an electric vehicle such as a hybrid vehicle, an electric automobile, or a fuel cell vehicle. As shown in FIG. 1, the battery pack 1 includes four battery modules 10, a junction box 11, an auxiliary device 12, and a battery case 31 that accommodates the above. The four battery modules 10 are arranged in two rows in a front-rear direction and in two rows in a left-right direction. Note that the number of the battery modules 10 can be freely set as long as there are two or more, and arrangement thereof is not particularly limited.

The battery modules 10 are electrically connected to each other via electrical connection members (not shown). Electric power stored in the battery modules 10 is supplied to a motor serving as a drive source of the vehicle and the like. Note that in the following description, the four battery modules 10 may be collectively referred to as a battery.

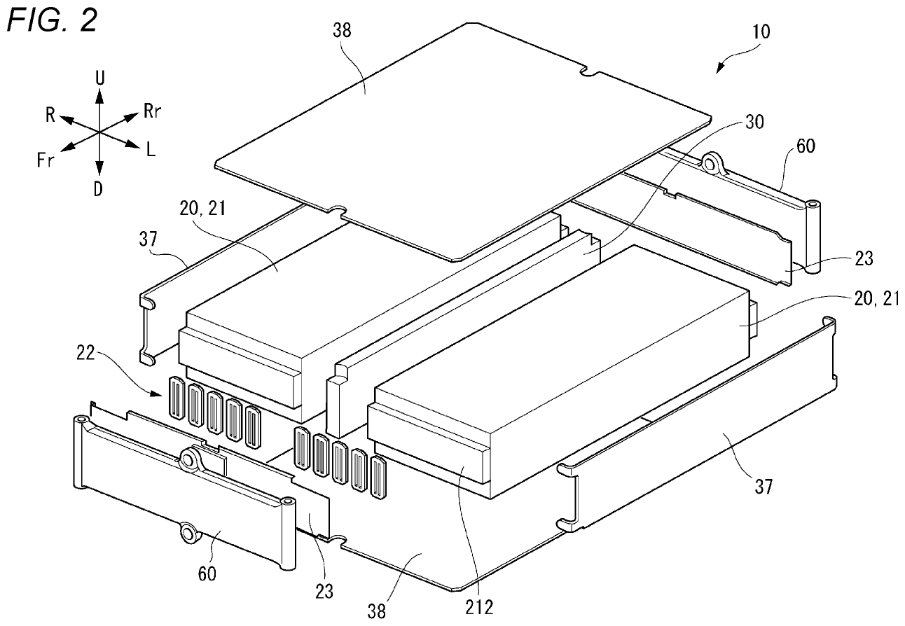

As shown in FIG. 2, the battery module 10 includes a cell laminate 20 in which a plurality of laminated cells 21 are laminated, an intermediate plate 30, a pair of end plates 37, a pair of restraining members 38, and a cover plate 60.

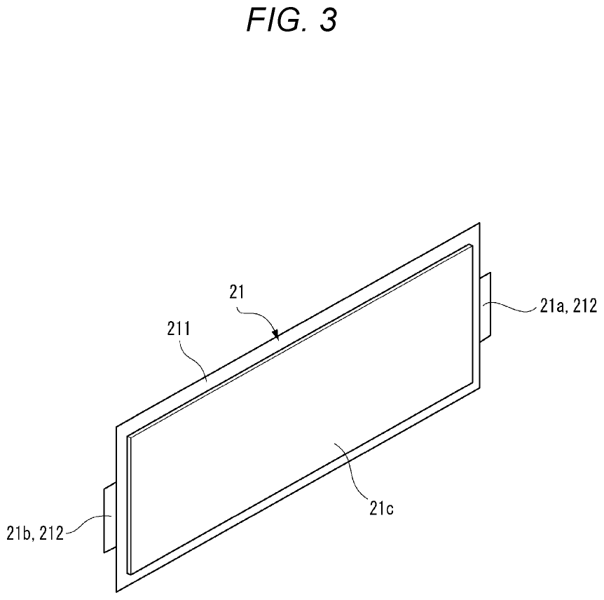

The laminated cell 21 is, for example, a solid-state battery. As shown in FIG. 3, the laminated cell 21 implemented by a solid-state battery includes a positive electrode to which a positive electrode tab 21a is coupled, a negative electrode to which a negative electrode tab 21b is coupled, a solid electrolyte disposed between the positive electrode and the negative electrode, and a laminate film 21c accommodating the above, and charge and discharge are performed by transferring lithium ions between the positive electrode and the negative electrode via the solid electrolyte. A sealing portion 211 is provided on a peripheral edge of the laminated cell 21. The positive electrode tab 21a extends from the sealing portion 211 on one end side in a longitudinal direction of the laminated cell 21, and the negative electrode tab 21b extends from the sealing portion 211 on the other end side in the longitudinal direction of the laminated cell 21. Note that the positive electrode tab 21a and the negative electrode tab 21b may both extend from the sealing portion 211 on one end side in the longitudinal direction of the laminated cell 21. Hereinafter, the positive electrode tab 21a and the negative electrode tab 21b are collectively referred to as an electrode tab 212. Note that the laminated cell 21 is not limited to using a solid electrolyte, and may use a semi-solid electrolyte or a liquid electrolyte.

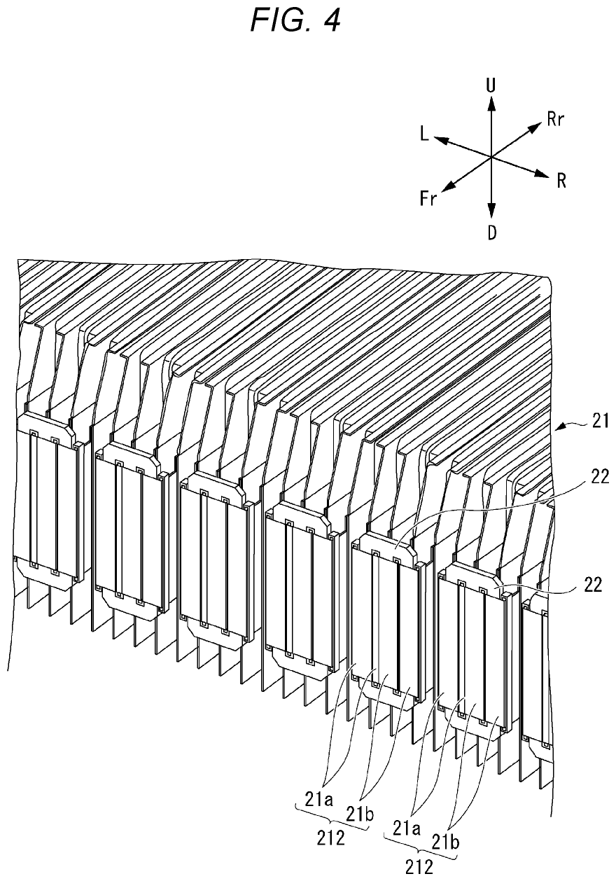

As shown in FIG. 4, the cell laminate 20 is configured by laminating the plurality of laminated cells 21 in the left-right direction. In the present embodiment, each laminated cell 21 is disposed such that the electrode tab 212 extends in the front-rear direction. Each laminated cell 21 is electrically connected to each other via a bus bar 22.

Returning to FIG. 2, the intermediate plate 30 is provided at an intermediate portion of the plurality of laminated cells 21 in the lamination direction (here, the left-right direction). Two or more intermediate plates 30 may be provided.

The pair of end plates 37 are provided on two ends of the plurality of laminated cells 21 in the lamination direction, respectively.

The pair of restraining members 38 face each other in an upper-lower direction and are coupled to the pair of end plates 37 to restrain the plurality of laminated cells 21. Here, the pair of restraining members 38 each have a plate shape and cover the plurality of laminated cells 21, the intermediate plate 30, and the pair of end plates 37 in the upper-lower direction. In this example, the restraining members 38 are plate-shaped, but as long as the end plates 37 can be restrained in the lamination direction, the shape thereof may be a ladder shape or restraint by a rod without covering the cells.

The cover plate 60 is provided outward than the plurality of laminated cells 21 in the front-rear direction and extends in the lamination direction. Two cover plates 60 are provided facing each other in the front-rear direction. As viewed in the front-rear direction, the cover plate 60 covers the bus bars 22 and the electrode tabs 212 of the respective laminated cells 21 via a bus bar cover 23 having an electrical insulating property so as to protect the bus bars 22 and the electrode tabs 212.

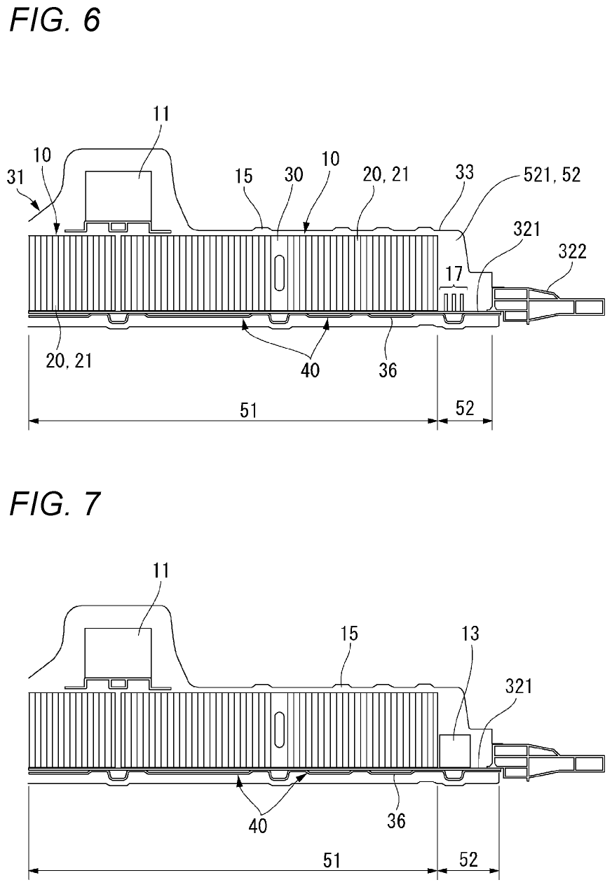

Returning to FIG. 1, the battery case 31 includes a battery tray 32 on which the plurality of battery modules 10 are placed, and an upper cover 33 that covers the battery modules 10 from above. An upper gap 15 is provided between the battery modules 10 and the upper cover 33, as shown in FIGS. 6, 7, and 9.

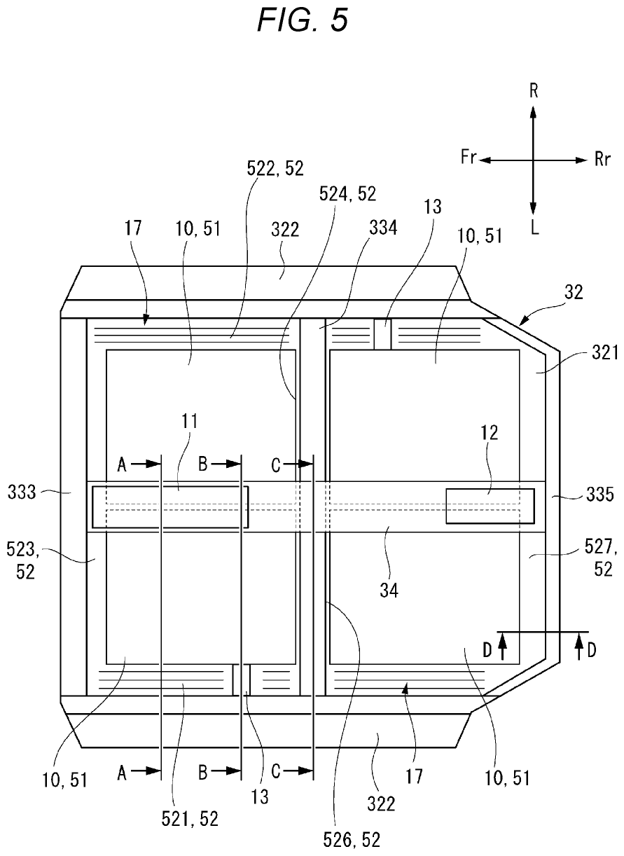

As shown in FIG. 5, the battery tray 32 includes a bottom plate 321 on which the battery modules 10 are placed, a pair of side frames 322 provided on left and right sides of the bottom plate 321, respectively, a front cross member 333, a central cross member 334, and a rear cross member 335 that couple the pair of side frames 322.

The front cross member 333 constitutes a front wall of the battery case 31, and the rear cross member 335 constitutes a rear wall of the battery case 31. The central cross member 334 divides an interior of the battery case 31 into two spaces of front and rear spaces. Two battery modules 10 are arranged on the left and right side in the front space, and two battery modules 10 are arranged on the left and right side in the rear space.

An upper frame 34 extending in the front-rear direction is bridged over the two battery modules 10 positioned on the left side and the two battery modules 10 positioned on the right side at left and right center portions of the battery case 31. On the upper frame 34, the junction box 11 is disposed on the front side, and the auxiliary device 12 is disposed on the rear side. Electronic components such as conductive members, fuses, and contactors that connect an electric power system inside the battery case 31 and a DC line outside the battery case 31 are arranged in the junction box 11. The auxiliary device 12 is, for example, a battery ECU.

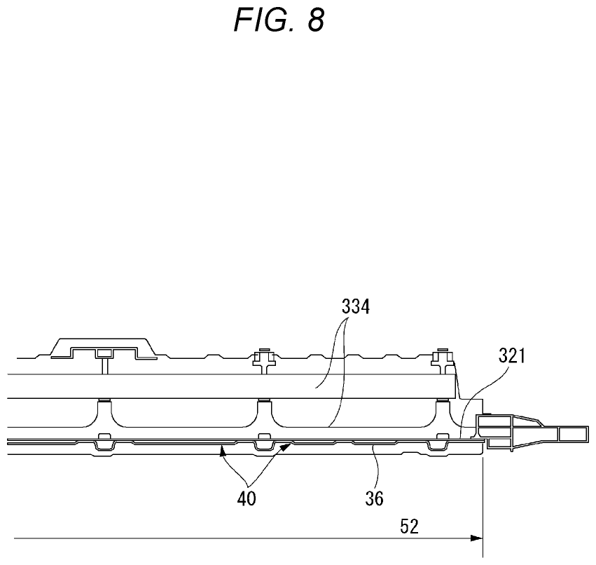

As shown in FIGS. 6 to 9, a cover plate 36 is attached below the bottom plate 321, and a water jacket 40 is formed between the bottom plate 321 and the cover plate 36.

The water jacket 40 is provided over substantially an entire surface of the bottom plate 321. In an internal space of the battery case 31, a region where the battery modules 10 are arranged is assumed as a first section 51, and a region where the battery modules 10 are not arranged is assumed as a second section 52, the water jacket 40 is provided across the first section 51 and the second section 52. In the first section, heat exchange is performed between the battery modules 10 and the water jacket 40. The battery modules 10 and the bottom plate 321 may be in direct contact or may be in indirect contact via a heat transfer material.

The second section 52 is provided above the water jacket 40 to surround the first section 51. That is, the second section 52 includes a left gap 521 between the two battery modules 10 positioned on the left side and the left side frame 322, a right gap 522 between the two battery modules 10 positioned on the right side and the right side frame 322, a front gap 523 between the two battery modules 10 positioned on the front side and the front cross member 333, a central front gap 524 between the two battery modules 10 positioned on the front side and the central cross member 334, a central rear gap 526 between the two battery modules 10 positioned on the rear side and the central cross member 334, and a rear gap 527 between the two battery modules 10 positioned on the rear side and the rear cross member 335.

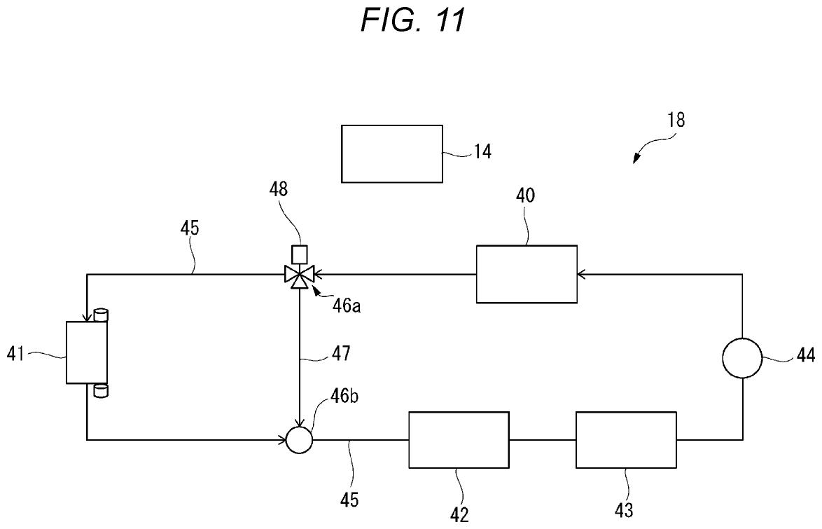

The water jacket 40 is connected to a battery cooling circuit 18 shown in FIG. 11. The battery cooling circuit 18 is provided outside the battery case 31 and connected to the battery case 31 through a pipe. The battery cooling circuit 18 and a fan 13 are controlled by a controller 14. Note that a control device that controls the fan 13 and a control device that controls the battery cooling circuit 18 may be the same or different. The battery cooling circuit 18 includes a main flow path 45 including the water jacket 40, a radiator 41, a chiller 42, a heater 43, and an electric pump 44, and a bypass flow path 47 that connects a branch 46a positioned between the water jacket 40 and the radiator 41 and a merging portion 46b positioned between the radiator 41 and the chiller 42. A three-way valve 48 is provided at the branch 46a. The controller 14 switches the three-way valve 48 between a bypass OFF state and a bypass ON state. When the three-way valve 48 is in the bypass OFF state, a refrigerant sent out from the electric pump 44 circulates through the water jacket 40, the radiator 41, the chiller 42, and the heater 43. On the other hand, when the three-way valve 48 is in the bypass ON state, the refrigerant sent out from the electric pump 44 bypasses the radiator 41 and circulates through the water jacket 40, the chiller 42, and the heater 43.

The battery cooling circuit 18 is driven by the controller 14 in four control modes: stop mode, heating mode, normal mode, and cooling mode. The stop mode is set, for example, when the vehicle is parked. In the stop mode, the electric pump 44 does not operate. The heating mode is set, for example, when the battery is at a low temperature. In the heating mode, by setting the three-way valve 48 to the bypass ON state, the heater 43 can warm the refrigerant while cutting off heat radiation from the radiator 41, thereby heating the battery. The normal mode is set, for example, when the vehicle is traveling. In the normal mode, the battery can be cooled by setting the three-way valve 48 to the bypass OFF state and dissipating the heat of the refrigerant from the radiator 41. The cooling mode is set, for example, when the battery is at a high temperature while the vehicle is traveling, or when the vehicle is in charging (including quick charging). In the cooling mode, in addition to dissipating the heat of the refrigerant from the radiator 41, the refrigerant in the battery cooling circuit 18 exchanges heat with a refrigerant in an air conditioning refrigeration cycle (not shown) in the chiller 42, thereby further cooling the battery. Since heat exchange capability of the radiator 41 is limited during charging and the like, heat exchange by the chiller 42 becomes effective.

Returning to FIG. 5, when the refrigerant is supplied to the water jacket 40, the battery modules 10 in the first section 51 is cooled via the bottom plate 321. In this case, a lower portion of the laminated cells 21 (lower portion of the battery modules 10) near the bottom plate 321 is cooled well, whereas an upper portion of the laminated cells 21 (upper portion of the battery modules 10) is difficult to be cooled, and therefore a temperature difference may occur between the upper and lower portions of the laminated cells 21 (battery modules 10). The electrode tabs 212 of the laminated cells 21 that are away from the bottom plate 321 are also difficult to be cooled, and there is a possibility that temperatures of these electrode tabs 212 may exceed a threshold value and the battery current may be limited.

In the present disclosure, the battery case 31 is provided with the fan 13, and the bottom plate 321 of the second section 52 is formed with a plurality of fins 17 which protrude. As a result, when the fan 13 is driven, air circulates between the first section 51 and the second section 52, so as to cool the upper portion of the laminated cells 21 (the upper portion of the battery modules 10), and to cool the electrode tabs 212 of the laminated cells 21. The air heated after exchanging heat with the laminated cells 21 dissipates heat to the water jacket 40 via the fins 17.

The battery case 31 of the present embodiment is provided with two fans 13, one of which is provided in the right gap 522 of the second section 52 and behind the central cross member 334, and the other of which is provided in the left gap 521 of the second section 52 and in front of the central cross member 334. These two fans 13 are arranged so as to send air in opposite directions in the front-rear direction.

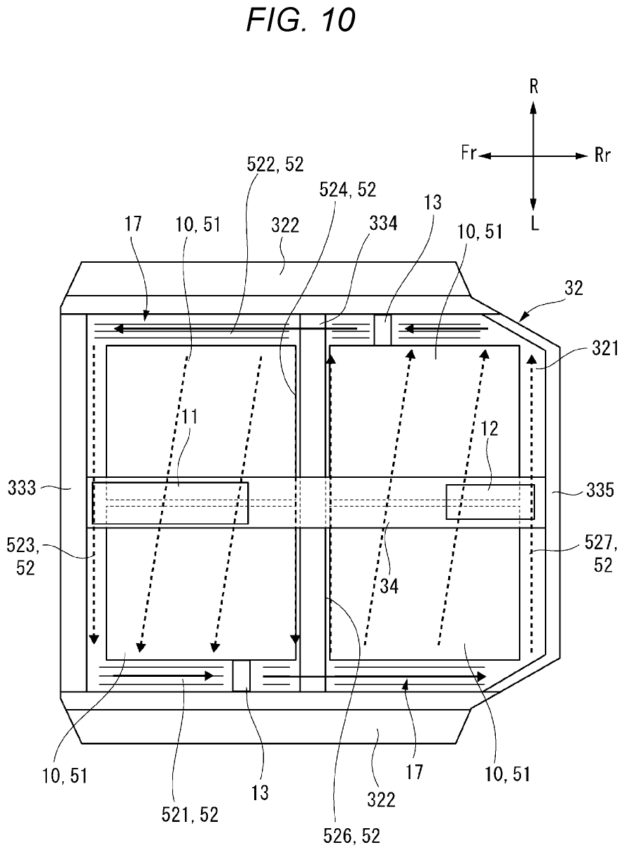

In the present embodiment, as shown in FIG. 10, the fan 13 on the right side sends out air toward the front side, and the fan 13 on the left side sends out air toward the rear side. The air sent out from the fan 13 flows forward or rearward through the gaps around the central cross member 334. Therefore, the front side of the fan 13 on the right side becomes a positive pressure region and the rear side thereof becomes a negative pressure region, while the front side of the fan 13 on the left side becomes a negative pressure region and the rear side thereof becomes a positive pressure region. As a result, inside the battery case 31, pressure distribution in the left-right direction from the positive pressure region of the second section 52 to the first section 51 (battery modules 10) to the negative pressure region of the second section 52 is formed, and air circulation within the battery case 31 can be made smooth.

That is, as shown by arrows in FIG. 10, inside the battery case 31, the air sent out from the fan 13 on the right side moves from the front side of the right gap 522 (the positive pressure region of the fan 13 on the right side), passes through the upper portion (upper gap 15) of the two battery modules 10 positioned on the front side, flows toward the front side of the left gap 521 (the negative pressure region of the fan 13 on the left side), and is sucked into the fan 13 on the left side. The air sent out from the fan 13 on the left side moves from the rear side of the left gap 521 (the positive pressure region of the fan 13 on the left side), passes through the upper portion (upper gap 15) of the two battery modules 10 positioned on the rear side, flows toward the rear side of the right gap 522 (the negative pressure region of the fan 13 on the right side), and is sucked into the fan 13 on the right side. In this way, the upper portion of the laminated cells 21 (the upper portion of the battery modules 10) can be cooled.

Since the junction box 11 attached to the upper frame 34 is disposed above the two battery modules 10 positioned on the front side, the junction box 11 is also cooled. Especially, when the conductive member of the junction box 11 comes into contact with the air circulating between the first section 51 and the second section 52, current limit due to heat generated by the conductive member can be avoided.

A part of the air sent out from the fan 13 on the right side moves from the front side of the right gap 522 (the positive pressure region of the fan on the right side), passes through the front gap 523 and the central front gap 524, flows forward the front side of the left gap 521 (the negative pressure region of the fan 13 on the left side), and is sucked into the fan 13 on the left side. A part of the air sent out from the fan 13 on the left side passes through the rear gap 527 and the central rear gap 526, flows toward the rear side of the right gap 522 (the negative pressure region of the fan 13 on the right side), and is sucked into the fan 13 on the right side. In this way, the electrode tabs 212 of the laminated cells 21 can be cooled.

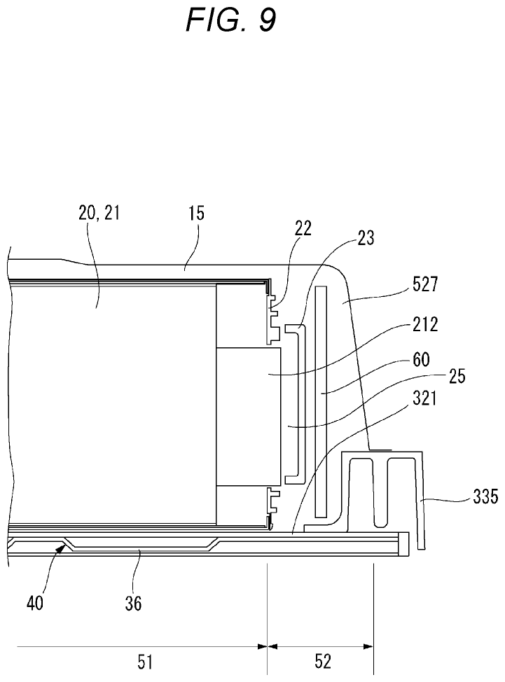

That is, as shown in FIG. 9, the air passing through the front gap 523, central front gap 524, rear gap 527, and central rear gap 526 cools the electrode tabs 212 of the laminated cells 21 while traveling through a space 25 formed between the electrode tabs 212 of the laminated cells 21 and the bus bar cover 23 and extending in the lamination direction. In this way, an air passage is formed by connecting the space 25 formed between the electrode tabs 212 of the laminated cells 21 and the bus bar cover 23 in the lamination direction, so that the electrode tabs 212 of the laminated cells 21 positioned near the cross members 333 to 335 can be appropriately cooled.

In the battery pack 1 configured in this way, the upper portion and the electrode tabs 212 of the laminated cells 21 are in contact with the air circulating inside the battery case 31 in the first section 51, so that the heat from the upper portion and the electrode tabs 212 of the laminated cells 21 can be dissipated to the water jacket 40 of the second section 52 via the air and the fins 17. In this way, the temperatures of the electrode tabs 212 can be lowered, so that current limit due to the temperatures of the electrode tabs 212 is prevented, and battery capacity can be used effectively.

The upper portion of the laminated cells 21 dissipates heat to the water jacket 40 via the air and the fins 17, and the lower portion of the laminated cells 21 dissipates heat to the water jacket 40 below the laminated cells 21 in the first section 51, so that temperature variation between the upper and lower portions of the laminated cells 21 can be prevented. As a result, it is possible to prevent the current limit on the battery, and it is possible to appropriately use the battery capacity.

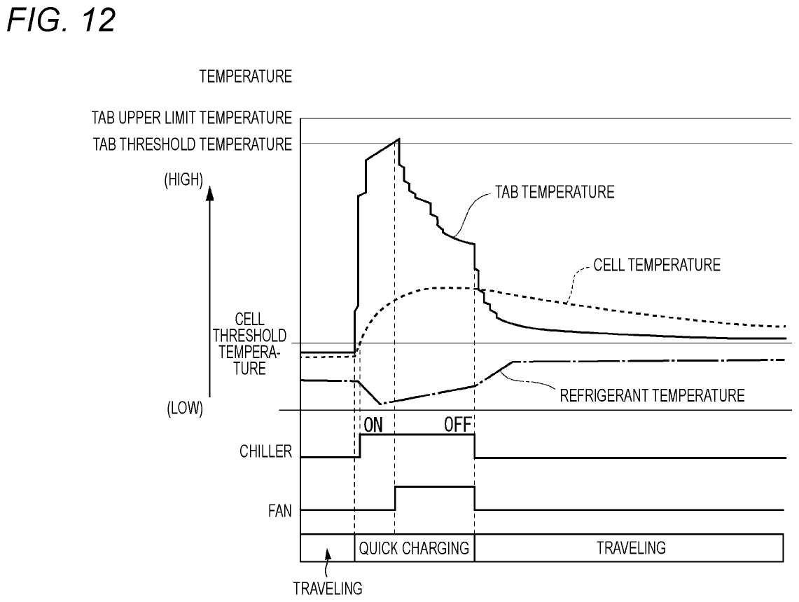

FIG. 12 is a graph illustrating battery cooling control.

As shown in FIG. 12, when charging is started and the temperatures of the laminated cells 21 reach a cell threshold temperature, the controller 14 changes the battery cooling circuit 18 from the stop mode to the cooling mode. That is, the controller 14 causes the battery cooling circuit 18 to operate when the temperatures of the laminated cells 21 are higher than the cell threshold temperature. Specifically, the controller 14 causes the chiller 42 to operate (ON) while driving the electric pump 44 and setting the three-way valve 48 to the bypass OFF state. In this way, the temperature of the refrigerant decreases, and the temperature of the battery also decreases. Note that the controller 14 causes the battery cooling circuit 18 to operate in the normal mode at the start of charging, and may change the control from the normal mode to the cooling mode when the temperatures of the laminated cells 21 exceed the cell threshold temperature.

However, even when the battery cooling circuit 18 is driven in the cooling mode, the temperatures of the electrode tabs 212 of the laminated cells 21 continue to rise. When the temperatures of the electrode tabs 212 of the laminated cells 21 reach a tab threshold temperature lower than a tab upper limit temperature at which current is limited, the controller 14 causes the fan 13 to operate. That is, the controller 14 causes the fan 13 to operate when the temperatures of the electrode tabs 212 of the laminated cells 21 are higher than the tab threshold temperature. In this way, the electrode tabs 212 are cooled, and the temperatures of the electrode tabs 212 are decreased. By causing the fan 13 to operate in this manner, it is possible to cool the electrode tabs 212, which could not be sufficiently cooled by the water jacket 40, and prevent the temperatures of the electrode tabs 212 from reaching the tab upper limit temperature.

As described above, in the battery cooling control described above, an object whose temperature is monitored differs between the cooling of the laminated cells 21 by the water jacket 40 and the cooling of the electrode tabs 212 by the air. The controller 14 controls the battery cooling circuit 18 according to the temperatures of the laminated cells 21, so that the ability of the water jacket 40 to cool the laminated cells 21 in the first section 51 is changeable according to the temperatures of the laminated cells 21. On the other hand, since the controller 14 controls the fan 13 according to the temperatures of the electrode tabs 212, the ability of the air inside the battery case 31 to cool the electrode tabs 212 is changeable according to the temperatures of the electrode tabs 212. Therefore, as compared with a case where the object whose temperature is monitored in the operation of the battery cooling circuit 18 and the object whose temperature is monitored in the operation of the fan 13 are the same object, while maintaining the temperatures of the laminated cells 21 at an appropriate temperature, current limit due to the temperatures of the electrode tabs 212 can be more effectively prevented.

Note that a temperature measurement method is not limited to directly measuring the temperatures of the laminated cells 21 or the temperatures of the electrode tabs 212 by bringing a temperature sensor into contact with the laminated cells 21 or the electrode tabs 212, and the temperatures of the laminated cells 21 or the electrode tabs 212 may be estimated from a temperature of a portion that reflects the temperatures of the laminated cells 21 or the electrode tabs 212. For example, the temperatures of the electrode tabs 212 may be estimated from the temperature of the air around the cell terminals. The temperatures of the laminated cells 21 may be estimated from a refrigerant temperature on an outlet side of the water jacket 40.

### Second Embodiment

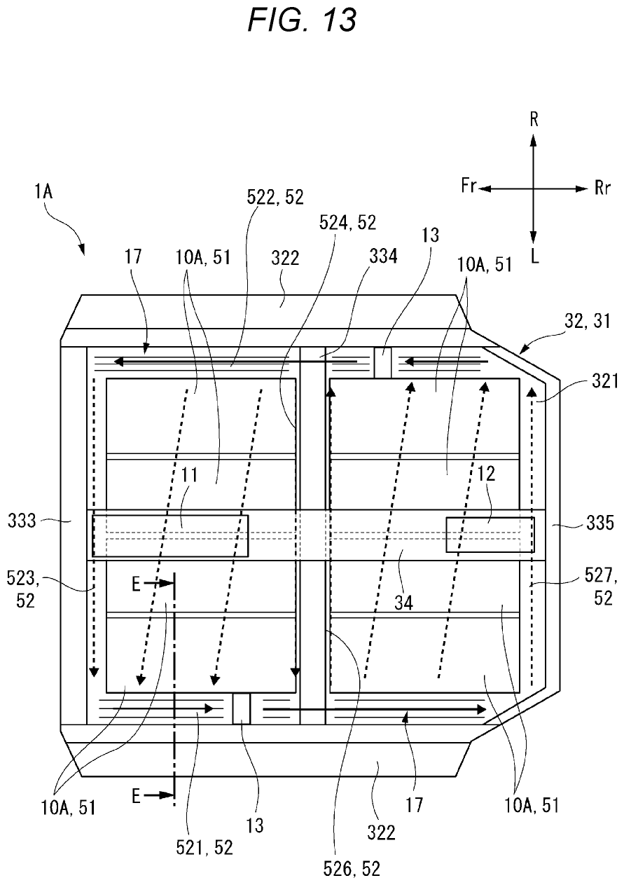

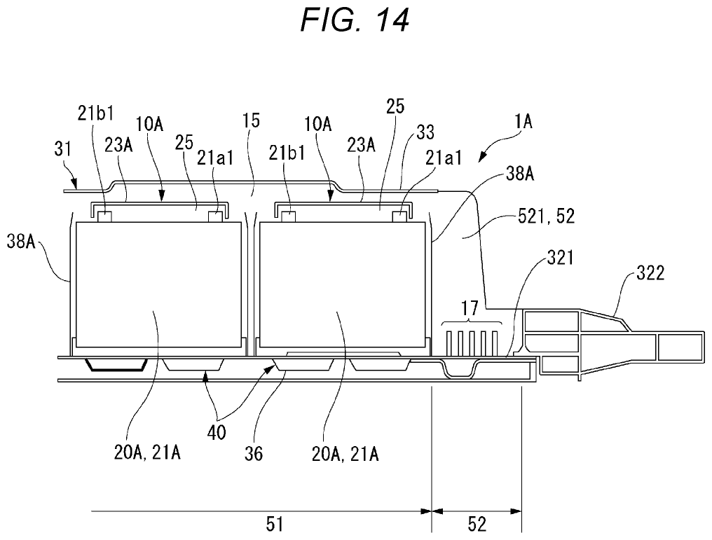

Next, a battery pack 1A according to a second embodiment will be described with reference to FIGS. 13 and 14. Note that in the following, only differences with the battery pack 1 of the first embodiment are described. In the drawings, the same components as in the first embodiment are designated by the same reference numerals, and the description thereof will be omitted.

As shown in FIG. 13, the battery pack 1A of the second embodiment includes eight battery modules 10A, the junction box 11, the auxiliary device 12, and the battery case 31 that accommodates the above. The eight battery modules 10A are arranged in two rows in the front-rear direction and in four rows in the left-right direction. Note that the number of the battery modules 10A can be freely set as long as there are two or more, and arrangement thereof is not particularly limited.

In the battery module 10A, a pair of end plates arranged at two ends in the lamination direction of a cell laminate 20A in which a plurality of square cells 21A are laminated are coupled by a pair of restraining members 38A arranged laterally, and a positive terminal 21al and a negative terminal 21b1 provided on an upper portion of the square cell 21A are covered with a bus bar cover 23A. An air passage is formed between the positive terminal 21al and the negative terminal 21b1 and the bus bar cover 23A by connecting the space 25 in the lamination direction.

That is, in the battery module 10A of the second embodiment, the positive terminal 21al and the negative terminal 21b1 are provided on the upper portion of the square cell 21A. Note that cylindrical cells may be laminated instead of the square cells 21A.

In the battery pack 1A configured in this way, when the fan 13 of the battery case 31 in which the battery modules 10A are mounted is driven, as shown by arrows in FIG. 14, similar to the arrows in FIG. 10 of the first embodiment, the air sent out from the fan 13 on the right side moves from the front side of the right gap 522 (the positive pressure region of the fan 13 on the right side), passes through the upper portion (upper gap 15) of the four battery modules 10 positioned on the front side, flows toward the front side of the left gap 521 (the negative pressure region of the fan 13 on the left side), and is sucked into the fan 13 on the left side. The air sent out from the fan 13 on the left side moves from the rear side of the left gap 521 (the positive pressure region of the fan 13 on the left side), passes through the upper portion (upper gap 15) of the four battery modules 10 positioned on the rear side, flows toward the rear side of the right gap 522 (the negative pressure region of the fan 13 on the right side), and is sucked into the fan 13 on the right side. The air passing through the upper gap 15 cools the positive terminal 21al and negative terminal 21b1 of the square cells 21A while traveling through the space 25 formed between the positive terminal 21al and negative terminal 21b1 of the square cell 21A and the bus bar cover 23A and extending in the lamination direction. In this way, an upper portion of the square cells 21A (upper portion of the battery modules 10A) can be cooled, and the positive terminal 21a1 and the negative terminal 21b1 can also be cooled.

Note that in the present embodiment, a part of the air sent out by the fan 13 also passes through the front gap 523, central front gap 524, rear gap 527, and central rear gap 526. The air passing through the front gap 523, central front gap 524, rear gap 527, and central rear gap 526 cools side surfaces of the square cells 21A (side surfaces of the battery modules 10A).

In this way, in the battery pack 1A as well, in the first section 51, the upper portion and the positive terminal 21al and the negative terminal 21b1 of the square cells 21A are in contact with the air circulating in the battery case 31, so that the heat of the upper portion and the positive terminal 21al and the negative terminal 21b1 of the square cells 21A can be dissipated to the water jacket 40 in the second section 52 via the air and the fins 17. As a result, the temperature of the positive terminal 21a1 and the negative terminal 21b1 can be lowered, so that current limit due to the temperature of the positive terminal 21al and the negative terminal 21b1 is prevented, and the battery capacity can be used effectively.

The upper portion of the square cells 21A dissipates heat to the water jacket 40 via the air and the fins 17, and the lower portion of the square cells 21A dissipates heat to the water jacket 40 below the square cells 21A in the first section 51, so that temperature variation between the upper and lower portions of the square cells 21A can be prevented. As a result, it is possible to prevent the current limit on the battery, and it is possible to appropriately use the battery capacity.

Although various embodiments have been described above with reference to the drawings, the present invention is not limited thereto. It is apparent that those skilled in the art can conceive of various modifications and changes within the scope described in the claims, and it is understood that such modifications and changes naturally fall within the technical scope of the present invention. In addition, constituent elements in the embodiment described above may be freely combined without departing from the gist of the present invention.

For example, the number of fans 13 is not limited to two, and may be one, or three or more. The fans are not limited to being disposed in the second section 52, and may be provided in the first section 51, on a wall surface of the battery case 31, or on the upper cover 33.

The water jacket 40 is not limited to being formed by the bottom plate 321 and the cover plate 36, and a separate water jacket may be attached externally or may be provided inside the battery case 31.

The number and shape of the fins 17 can be selected as appropriate. The fins 17 may be provided only in a part of the second section 52, or may be provided over the entire second section 52.

In the present description, at least the following matters are described. Although corresponding constituent elements or the like in the above-described embodiments are shown in parentheses, the present invention is not limited thereto.

(1) A battery pack (battery pack 1, 1A), including:
a plurality of cells (laminated cell 21, square cell 21A) having a positive terminal (positive electrode tab 21a, positive terminal 21a1) and a negative terminal (negative electrode tab 21b, negative terminal 21b1);
a plurality of battery modules (battery module 10, 10A) in which the plurality of cells are laminated;
a battery case (battery case 31) accommodating the plurality of battery modules; and
a water jacket (water jacket 40) connected to a heat exchange system (battery cooling circuit 18) outside the battery case with a pipe and provided inside or outside the battery case to cool the plurality of battery modules from below,
in which the battery case includes:
   a first section (first section 51) in which the plurality of battery modules are arranged, and heat exchange between the plurality of battery modules and the water jacket is performed;
   a second section (second section 52) provided above the water jacket, and in which no battery module is disposed;
   a gap (upper gap 15, front gap 523, central front gap 524, central rear gap 526, rear gap 527) provided between the plurality of cells and an inner wall of the battery case, and through which air is capable of passing;
   a fin (fin 17) provided in the second section, and formed to protrude from a side of the water jacket; and
   a fan (fan 13) circulating air across the first section and the second section.

According to (1), since the upper portion and the cell terminals of the cells are in contact with the air circulating inside the battery case in the first section, the heat from the upper portion and the cell terminals of the cells can be dissipated to the water jacket of the second section via the air and the fin. Thus, since the temperatures of the cell terminals can be lowered, current limit due to the temperatures of the cell terminals is prevented, and battery capacity can be used effectively. The upper portion of the cells dissipates heat to the water jacket via the air and the fin, and the lower portion of the cells dissipates heat to the water jacket below the cells in the first section. Therefore, temperature variation between the upper and lower portions of the cells can be prevented. As a result, it is possible to prevent the current limit on the battery, and it is possible to appropriately use the battery capacity.

(2) The battery pack according to (1),
in which the fan and the heat exchange system are controlled by a controller (controller 14), and
the controller causes the heat exchange system to operate when a temperature of the cell is higher than a first threshold (cell threshold temperature), and causes the fan to operate when a terminal temperature of the cell is higher than a second threshold (tab threshold temperature).

According to (2), an object whose temperature is monitored differs between the cooling of the cells by the water jacket and the cooling of the cell terminals by the air, and the ability of the water jacket to cool the cells in the first section changes depending on the temperatures of the cells, and the ability of the air within the battery case to cool the cell terminals changes depending on the temperatures of the cell terminals. Therefore, as compared with a case where the object whose temperature is monitored in the operation of the heat exchange system outside the battery case and the object whose temperature is monitored in the operation of the fan are the same object, while maintaining the temperatures of the cells at an appropriate temperature, current limit due to the temperatures of the cell terminals can be more effectively prevented. Note that a temperature measurement method is not limited to directly measuring the temperatures of the cells or the temperatures of the cell terminals by bringing a temperature sensor into contact with the cells or the cell terminals, and the temperatures of the cells or the cell terminals may be estimated from a temperature of a portion that reflects the temperatures of the cells or the cell terminals. For example, the temperatures of the cell terminals may be estimated from the temperature of the air around the cell terminals. The temperatures of the cells may be estimated from a refrigerant temperature on an outlet side of the water jacket.

(3) The battery pack according to (1),
in which a junction box (junction box 11) is accommodated in the battery case, and
the junction box is disposed such that the air circulated between the first section and the second section by the fan is in contact with a conductive member of the junction box.

According to (3), since the conductive member in the junction box is also cooled by the air flow within the battery case, current limit is prevented during quick charging.

(4) The battery pack according to (1),
in which the second sections are positioned outside the first section and on both sides of the first section, and
the fan is disposed in the second section.

According to (4), since the fan is disposed in the second section used as a collision stroke where no battery module is placed, as compared with a case where the fan is disposed above the battery modules (first section), the space within the pack can be used effectively, and an increase in a height of the battery pack can be prevented.

(5) The battery pack according to (4),
in which the fans are disposed in the second sections respectively,
each of the second sections has:
   a positive pressure region on a side to which air is discharged from the fan, with respect to the fan; and
   a negative pressure region on a side from which the air is introduced into the fan, with respect to the fan,
the positive pressure region of the second section on one side and the negative pressure region of the second section on an other side face each other across the first section, and
the negative pressure region of the second section on the one side and the positive pressure region of the second section on the other side face each other across the first section.

According to (5), pressure distribution from the positive pressure region of the second section to the first section (battery modules) to the negative pressure region of the second section is formed, and air circulation within the battery case can be made smoother.

(6) The battery pack according to (1),
in which each of the plurality of battery modules includes a terminal insulating cover (bus bar cover 23, 23A) that covers at least one cell terminal (electrode tab 212) of the positive terminal and the negative terminal of the cell, and a space (space 25) extending in a lamination direction of the cells is provided between the terminal insulating cover and the cell terminal.

According to (6), since the space around the cell terminal becomes an air passage, the cell terminal can be efficiently cooled while being insulated.

(7) The battery pack according to (1),
in which the second sections are positioned outside the first section and on both sides of the first section, and
an air passage (central front gap 524, central rear gap 526) is formed between the adjacent battery modules or between the battery module and a cross member, the air passage being perpendicular to an extending direction of the second section and connecting the second section on one side and the second section on an other side.

When there are cell terminals on both sides of a cell, one terminal is positioned closer to another battery module or the cross member. According to (7), since the air passage is provided between the adjacent battery modules or between the battery module and the cross member, as compared with a case where the battery modules are brought into close contact with each other without providing an air passage, the cell terminals positioned near another battery module or the cross member can also be efficiently cooled.

What is claimed is:

1. A battery pack, comprising:
a plurality of cells having a positive terminal and a negative terminal;
a plurality of battery modules in which the plurality of cells are laminated;
a battery case accommodating the plurality of battery modules; and
a water jacket connected to a heat exchange system outside the battery case with a pipe, and provided inside or outside the battery case to cool the plurality of battery modules from below,
wherein the battery case includes:
a first section in which the plurality of battery modules are arranged, and heat exchange between the plurality of battery modules and the water jacket is performed;
a second section provided above the water jacket, and in which no battery module is disposed;
a gap provided between the plurality of cells and an inner wall of the battery case, and through which air is capable of passing;
a fin provided in the second section, and formed to protrude from a side of the water jacket; and
a fan circulating air across the first section and the second section.

2. The battery pack according to claim 1,
wherein the fan and the heat exchange system are controlled by a controller, and
the controller causes the heat exchange system to operate when a temperature of the cell is higher than a first threshold, and causes the fan to operate when a terminal temperature of the cell is higher than a second threshold.

3. The battery pack according to claim 1,
wherein a junction box is accommodated in the battery case, and
the junction box is disposed such that the air circulated between the first section and the second section by the fan is in contact with a conductive member of the junction box.

4. The battery pack according to claim 1,
wherein the second sections are positioned outside the first section and on both sides of the first section, and
the fan is disposed in the second section.

5. The battery pack according to claim 4,
wherein the fans are disposed in the second sections respectively,
each of the second sections has:
a positive pressure region on a side to which air is discharged from the fan, with respect to the fan; and
a negative pressure region on a side from which the air is introduced into the fan, with respect to the fan,
the positive pressure region of the second section on one side and the negative pressure region of the second section on an other side face each other across the first section, and
the negative pressure region of the second section on the one side and the positive pressure region of the second section on the other side face each other across the first section.

6. The battery pack according to claim 1,
wherein each of the plurality of battery modules includes a terminal insulating cover that covers at least one cell terminal of the positive terminal and the negative terminal of the cell, and
a space extending in a lamination direction of the cells is provided between the terminal insulating cover and the cell terminal.

7. The battery pack according to claim 1,
wherein the second sections are positioned outside the first section and on both sides of the first section, and
an air passage is formed between the adjacent battery modules or between the battery module and a cross member, the air passage being perpendicular to an extending direction of the second section and connecting the second section on one side and the second section on an other side.
